(19) United States
(12) Patent Application Publication
(10) Pub. No.: US 2014/0089673 A1
(43) Pub. Date: Mar. 27, 2014

(54) BIOMETRIC IDENTIFICATION METHOD AND APPARATUS TO AUTHENTICATE IDENTITY OF A USER OF A WEARABLE DEVICE THAT INCLUDES SENSORS

(71) Applicant: Michael Luna, San Jose, CA (US)

(72) Inventor: Michael Luna, San Jose, CA (US)

(73) Assignee: AliphCom, San Francisco, CA (US)

(21) Appl. No.: 13/831,139

(22) Filed: Mar. 14, 2013

Related U.S. Application Data
(60) Provisional application No. 61/705,599, filed on Sep. 25, 2012.

(51) Int. Cl. H04L 29/06

(52) U.S. Cl. CPC H04L 63/0861
USPC 713/186

(57) ABSTRACT

Embodiments relate generally to electrical and electronic hardware, computer software, wired and wireless network communications, and wearable computing devices for facilitating health and wellness-related information, and more particularly, to an apparatus or method for using a wearable device (or carried device) having sensors to identify a wearer and/or generate a biometric identifier for security and authentication purposes (e.g., using the generated biometric identifier similar to a passcode). In one embodiment, a method includes determining a pattern of activity based on a first activity and a second activity, comparing data representing the pattern of activity against match data associated with a habitual activity, and authenticating an identity of a user associated with a wearable device.

### CROSS-RELATED APPLICATIONS

This application claims the benefit of U.S. Provisional Patent Application No. 61/705,599 filed on Sep. 25, 2012, which is incorporated by reference herein for all purposes. This application also is related to U.S. Nonprovisional patent application Ser. No. 13/802,283, filed Mar. 13, 2013, with Attorney Docket No. ALI-150 and U.S. Nonprovisional patent application Ser. No. 13/802,409, filed Mar. 13, 2013, with Attorney Docket No. ALI-151, all of which are incorporated by reference for all purposes.

### FIELD

Embodiments relate generally to electrical and electronic hardware, computer software, wired and wireless network communications, and wearable computing devices for facilitating health and wellness-related information, and more particularly, to an apparatus or method for using a wearable device (or carried device) having sensors to identify a wearer and/or generate a biometric identifier for security and authentication purposes.

### BACKGROUND

Devices and techniques to gather information to identify a human by its characteristics or traits, such as a fingerprint of a person, while often readily available, are not well-suited to capture such information other than by using conventional data capture devices to accurately identify a person for purposes of authentication. Conventional approaches to using biometric information typically focus on a single, biological characteristic or trait.

While functional, the traditional devices and solutions to collecting biometric information are not well-suited for authenticating whether a person is authorized to engage in critical activities, such as financially-related transactions that include withdrawing money from a bank. The traditional approaches typically lack capabilities to reliably determine the identity of a person for use in financial transactions or any other transaction based on common techniques for using biometric information. These traditional devices and solutions thereby usually limit the applications for which biometric information can be used. Thus, conventional typically require supplemental authentication along with the biometric information.

Thus, what is needed is a solution for data capture and authentication devices, such as for wearable devices, without the limitations of conventional techniques.

### BRIEF DESCRIPTION OF THE DRAWINGS

Various embodiments or examples (“examples”) of the invention are disclosed in the following detailed description and the accompanying drawings:

FIG. 1 illustrates an exemplary biometric identifier generator based on data acquired by one or more sensors disposed in a wearable data-capable band, according to some embodiments;

FIG. 2 is a diagram depicting an example of an identifier constructor in association with a wearable device, according to some embodiments;

FIG. 3 is a functional diagram depicting an example of the types of data used by an identifier constructor in association with a wearable device, according to some embodiments;

FIG. 4 is a diagram depicting an example an identifier constructor configured to adapt to changes in the user, according to some embodiments;

FIG. 5 is an example flow diagram for generating a LifeScore as a biometric identifier, according to some embodiments; and

FIG. 6 illustrates an exemplary computing platform disposed in or associated with a wearable device in accordance with various embodiments.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

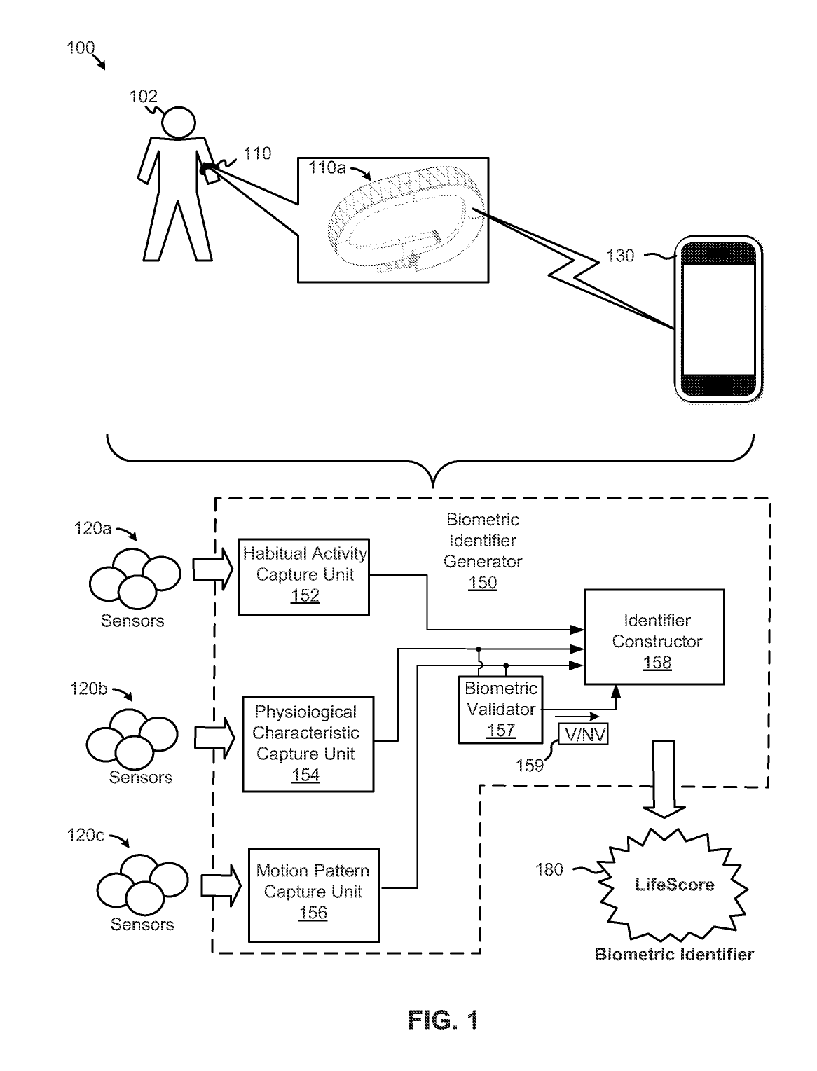

FIG. 1 illustrates an exemplary biometric identifier generator based on data acquired by one or more sensors disposed in a wearable data-capable band, according to some embodiments. Diagram 100 depicts a person 102 wearing or carrying a wearable device 110 configured to capture data for authenticating the identity of person 102. Examples of data captured for authenticating an identity include data related to activities of user 102, including habitual activities, data related to physiological characteristics, including biological-related functions and activities, data related to motion pattern characteristics, including motion-related patterns of, for example, the limbs or other portions of user 102 (e.g., patterns of limb movement constituting a gait or a portion thereof) and/or a corresponding activity in which user 102 is engaged. Biometric identifier generator 150 is not limited to the above-described data and can use any types of data can be captured and/or used for purposes of authenticating an identity of a user.

Also shown in FIG. 1 is a biometric identifier generator 150 configured to acquire data generated by or at, for example, subsets of one or more sensors 120a, 120b, and 120c, and is further configured to generate a biometric identifier (“LifeScore”) 180 based on the acquired data. A LifeScore, as biometric identifier 180, may include data that (e.g., in the aggregate or otherwise interrelated or integrated) can be used to uniquely and positively identify an individual and/or distinguish the individual from a relatively large sample size of other individuals. In at least some embodiments, a LifeScore of user 102 may be a composite of one or more habitual activities, one or more motion pattern characteristics, and/or one or more physiological and biological characteristics. For example, biometric identifier 180 can be based on an aggregation of data representative of physiological (and biological) characteristics from one or more sensors 120b, data representative of physical activities from one or more sensors 120a (e.g., a single activity, such as sleeping, walking, eating, etc., or a combination of activities that can, for example, constitute a daily routine), and/or motion patterns from one or more sensors 120c. In the example shown, biometric identifier generator 150 may be configured to include a habitual activity capture unit 152, a physiological characteristic capture unit 154, and a motion pattern capture unit 156. Also included is an identifier constructor 158 configured to generate a composite biometric identifier 180 based on data or subsets of data from habitual activity capture unit 152, physiological characteristic capture unit 154, and motion pattern capture unit 156.

Habitual activity capture unit 152 is configured to acquire data representing physical and/or behavior characteristics associated with or derived from one or more activities. In some embodiments, habitual activity capture unit 152 can also be configured to capture data for individual activities and to characterize (e.g., categorize) such data. For example, habitual activity capture unit 152 can identify an activity in which user 102 is participating, as well as the characteristics of the activity (e.g., the rate at which the activity is performed, the duration of time over which the activity is performed, the location of the activity, the identities of other people related to the performance of the activity (e.g., the identities of people with which user 102 interacts, such as by phone, email, text, or in any other manner), the time of day, and the like). Further, habitual activity capture unit 152 can identify a broader activity composed of sub-activities. For example, habitual activity capture unit 152 can determine that user 102 is at work if he or she walks in patterns (e.g., walking in patterns such as between one's desk or cubical to others' desks or cubicles), converses with other people (face-to-face and over the phone), and types on a keyboard (e.g., interacts with a computer) from the hours of 8 am to 7 pm on a weekday. Thus, habitual activity capture unit 152 can identify a first sub-activity of walking having activity characteristics of “direction” (i.e., in a pattern), “origination and destination” of walking (i.e., to and from cubicles or points in space), a time of day of the sub-activity, a location of the sub-activity, etc.; a second sub-activity of conversing having activity characteristics of “a medium” (i.e., face-to-face or over the phone), a time of day of the sub-activity, a location of the sub-activity, etc.; and a third sub-activity of interacting with a computer with characteristics defining the interaction (e.g., typing, mouse selections, swiping an interface), the time of day, etc. The sub-activities and characteristics can used to match against authentication data to confirm an activity pattern that match valid, habitual activities. In some embodiments, an activity can be determined by the use of one or more accelerometers, which can be included in a subset of sensors 120a. Further, motion pattern capture unit 156 can be used by habitual activity capture unit 152 to identify certain patterns of motion (e.g., steps or strides) that constitute an activity, such as walking or jogging.

Examples of such activities include physical activities, such as sleeping, running, cycling, walking, swimming, as well as other aerobic and/or anaerobic activities. Also included are incidental activities that are incidental (i.e., not intended as exercise) to, for example, a daily routine, such as sitting stationary, sitting in a moving vehicle, conversing over a telephone, typing, climbing stairs, carrying objects (e.g., groceries), reading, shopping, showering, laundering clothes, cleaning a house, and other activities typically performed by a person in the course of living a certain lifestyle. Examples of characteristics of the above-mentioned activities include but are not limited to “who” user 102 has called (e.g., data can include other aspects of the call, such as duration, time, location, etc., of the phone call to, for example, the mother of user 102), what time of the day user 102 wakes up and goes to bed, the person with whom user 102 texts the most (including duration, time, location, etc.), and other aspects of any other types of activity.

Such activities can each be performed differently based on the unique behaviors of each individual, and these activities are habitually performed consistently and generally periodically. Therefore, multiple activities can constitute a routine, whereby individuals each can perform such routines in individualized manners. As used herein, the term “habitual activity” can refer to a routine or pattern of behavior that is repeatable and is performed in a consistent manner such that aspects of the pattern of behavior can be predictable for an individual. In view of the foregoing, the term “habitual activities” can refer to a series of activities (habitual or otherwise), which may be performed in a certain order, whereby the collective performance of the habitual activities over a period of time (e.g., over a typical workday) is unique to aspects of the psychology of user 102 (i.e., physical manifestations of the mental functions that gives rise to decisions of what activities to perform and the timing or order thereof) and the physiological and/or biology of user 102. Therefore, habitual activities and the patterns of their performance can be used to uniquely identify user 102. Biometric identifier generator 150 is configured to determine which deviations, as well as the magnitude of the deviations, from expected data values (e.g., data representing a daily routine) that can be used for authentication purposes. For example, biometric identifier generator 150 can adapt variations in activities performed by user 102, such as going to a doctor's office during a workday. As such, one or more omitted sub-activities or one or more different sub-activities can be tolerated without determining that the wearer of wearable device 110a is no longer user 102. Various criteria can be used by habitual activity capture unit 152 to determine a variation from a pattern of habitual activities that are used to identify user 102. For example, if three or more sub-activities are omitted or are new, but these sub-activities are within a radial distance from where other valid patterns of habitual activities occur, then the deviations may be acceptable. But as another example, if one sub-activity is new that exceeds the radial distance from where other valid patterns of habitual activities occur (e.g., a new activity is detected in a different location that is, for example, a hundred miles beyond the radial distance), then the deviations may not be acceptable.

According to some examples, activities that may constitute a “habitual activity” and/or corresponding characteristics can be determined and/or characterized by activity-related managers, such as a nutrition manager, a sleep manager, an activity manager, a sedentary activity manager, and the like, examples of which can be found in U.S. patent application Ser. No. 13/433,204, filed on Mar. 28, 2012 having Attorney Docket No. ALI-013CIP1; U.S. patent application Ser. No. 13/433,208, filed Mar. 28, 2012 having Attorney Docket No. ALI-013CIP2; U.S. patent application Ser. No. 13/433,208, filed Mar. 28, 2012 having Attorney Docket No. ALI-013CIP3; U.S. patent application Ser. No. 13/454,040, filed Apr. 23, 2012 having Attorney Docket No. ALI-013CIP1CIP1; and U.S. patent application Ser. No. 13/627,997, filed Sep. 26, 2012 having Attorney Docket No. ALI-100; all of which are incorporated herein by reference for all purposes.

Physiological characteristic capture unit 154 is configured to acquire data representing physiological and/or biological characteristics of user 102 from sensors 120b that can acquired before, during, or after the performance of any activity, such as the activities described herein. In some embodiments, physiological characteristic capture unit 154 can also be configured to capture data for individual physiological characteristics (e.g., heart rate) and to either characterize (e.g., categorize) such data or use the physiological data to derive other physiological characteristics (e.g., VO2 max). Physiological characteristic capture unit 154, therefore, is configured to capture physiological data, analyze such data, and characterize the physiological characteristics of the user, such as during different activities. For example, a 54 year old women who is moderately active will have, for example, heart-related physiological characteristics during sleep and walking that are different than male user under 20 years old. As such, physiological characteristics can be used to distinguish user 102 from other persons that might wear wearable device 110a. Sensor data from sensors 120b includes data representing physiological information, such as skin conductivity, heart rate (“HR”), blood pressure (“BP”), heart rate variability (“HRV”), pulse waves, Mayer waves, respiration rates and cycles, body temperature, skin conductance (e.g., galvanic skin response, or GSR), and the like. Optionally, sensor data from sensors 120b also can include data representing location (e.g., GPS coordinates) of user 102, as well as other environmental attributes in which user 102 is disposed (e.g., ambient temperatures, atmospheric pressures, amounts of ambient light, etc.). In some embodiments, sensors 120b can include image sensors configured to capture facial features, audio sensors configured to capture speech patterns and voice characteristics unique to the physiological features (e.g., vocal cords, etc.) of individual 102, and any other type of sensor for capturing data about any attribute of a user.

Motion pattern capture unit 156 is configured to capture data representing motion from sensors 120c based on patterns of three-dimensional movement of a portion of a wearer, such as a wrist, leg, arm, ankle, head, etc., as well as the motion characteristics associated with the motion. For example, the user's wrist motion during walking exhibits a “pendulum-like” motion pattern over time and three-dimensional space. During walking, the wrist and wearable device 110a is generally at waist-level as the user walks with arms relaxed (e.g., swinging of the arms during walking can result in an arc-like motion pattern over distance and time). Given the uniqueness of the physiological structure of user 102 (e.g., based on the dimensions of the skeletal and/or muscular systems of user 102), motion pattern capture unit 156 can derive quantities of foot strikes, stride length, stride length or interval, time, and other data (e.g., either measurable or derivable) based on wearable device 110a being disposed either on a wrist or ankle, or both. In some embodiments, an accelerometer in mobile computing/communication device 130 can be used in concert with sensors 120c to identify a motion pattern. In view of the foregoing, motion pattern capture unit 156 can be used to capture data representing a gait of user 102, thereby facilitating the identification of a gait pattern associated to the particular gait of user 102. As such, an identified gait pattern can be used for authenticating the identity of user 102. Note, too, that motion pattern capture unit 156 may be configured to capture other motion patterns, such of that generated by an arm of user 102 (including wearable device 110a) that performs a butterfly swimming stroke. Other motion patterns can be identified from sensors 120c to indicate the motions in three-dimensional space when brushing hair or teeth, or any other pattern of motion to authenticate or identify user 102.

Identifier constructor 158 is configured to generate a composite biometric identifier 180 based on data or subsets of data from habitual activity capture unit 152, physiological characteristic capture unit 154, and motion pattern capture unit 156. For example, subsets of data from habitual activity capture unit 152, physiological characteristic capture unit 154, and motion pattern capture unit 156 can be expressed in various different ways (e.g., matrices of data) based on any of the attributes of the data captured (e.g., magnitude of a pulse, frequency of a heartbeat, shape of an ECG waveform or any waveform, etc.). In some examples, identifier constructor 158 is configured to compare captured data against user-related data deemed valid and authentic (e.g., previously authenticated data that defines or predefines data representing likely matches when compared by the captured data) to determine whether LifeScore 180 identifies positively user 102 for authorization purposes.

Further, FIG. 1 depicts biometric identifier generator 150 including a biometric validator 157 configured to determine modes of operation of biometric identifier generator 150 in which an authentication of the identity of a user is either validated or invalidated. As shown, biometric validator 157 is configured to receive data from physiological characteristic capture unit 154 and/or motion pattern capture unit 156. In some embodiments, biometric validator 157 is configured to determine the validity of an authenticated identify as a function of the presence and/or quality of a physiological signal (e.g., heart rate) and/or the presence and/or quality of patterned motion (e.g., the gait of the user). According to some embodiments, biometric validator 157 is configured to operate as a “wore/not-worn detector.” In particular, biometric validator 157 determines when wearable device 110a is removed from the wearer, and generates valid/not-valid (“V/NV”) signal 159 that includes data indicating the LifeScore is invalid due to the removal of the wearable device. Consequently, unauthorized use is prevented when identifier constructor 158 receives signal 159, and, in response, causes invalidation of LifeScore 180. That is, invalidating the biometric identifier (or LifeScore 180) can be responsive to a disassociation between the wearable device and the user. An example of a disassociation is a physical separation between the wearable device and the user for a threshold period of time. Further, biometric validator 157 determines when wearable device 110a is being worn again by the wearer, and generates valid/not-valid (“V/NV”) signal 159 that includes data indicating the LifeScore 180 is valid. In this case, authorized use is permitted when identifier constructor 158 receives signal 159 specifying that data from physiological characteristic capture unit 154 and/or motion pattern capture unit 156 is valid (i.e., the wearable device is being worn by an authenticated user), which causes identifier constructor 158 to validate the authenticity of LifeScore 180. An authenticated LifeScore 180 can then be used as a personal identification number (“PIN”) for financial transactions, for example, or as a passcode or an equivalent.

According to various embodiments, any or all of the elements (e.g., sensors 120a to 120c and biometric identifier generator 150), or sub-elements thereof, can be disposed in wearable device 110a or in mobile computing/communication device 130, or such sub-elements can be distribute among wearable device 110a and in mobile computing/communication device 130 as well as any other computing device (not shown). Wearable device 110a is not limited to a human as user 102 and can be used in association with any animal, such as a pet. Note that more or fewer units and sets of data can be used to authenticate user 102. Examples of wearable device 110a, or portions thereof, may be implemented as disclosed or otherwise suggested by U.S. patent application Ser. No. 13/181,500 filed Jul. 12, 2011 (Docket No. ALI-016), entitled “Wearable Device Data Security,” and U.S. patent application Ser. No. 13/181,500 filed Jul. 12, 2011, entitled “Wearable Device Data Security,” U.S. patent application Ser. No. 13/181,513 filed Jul. 12, 2011 (Docket No. ALI-019), entitled “Sensory User Interface,” and U.S. patent application Ser. No. 13/181,498 filed Jul. 12, 2011 (Docket No. ALI-018), entitled “Wearable Device and Platform for Sensory Input,” all of which are herein incorporated by reference.

In some examples, wearable device 110a is configured to dispose one or more sensors (e.g., physiological sensors) 120b at or adjacent distal portions of an appendage or limb. Examples of distal portions of appendages or limbs include wrists, ankles, toes, fingers, and the like. Distal portions or locations are those that are furthest away from, for example, a torso relative to the proximal portions or locations. Proximal portions or locations are located at or near the point of attachment of the appendage or limb to the torso or body. In some cases, disposing the sensors at the distal portions of a limb can provide for enhanced sensing as the extremities of a person's body may exhibit the presence of an infirmity, ailment or condition more readily than a person's core (i.e., torso).

In some embodiments, wearable device 110a includes circuitry and electrodes (not shown) configured to determine the bioelectric impedance (“bioimpedance”) of one or more types of tissues of a wearer to identify, measure, and monitor physiological characteristics. For example, a drive signal having a known amplitude and frequency can be applied to a user, from which a sink signal is received as bioimpedance signal. The bioimpedance signal is a measured signal that includes real and complex components. Examples of real components include extra-cellular and intra-cellular spaces of tissue, among other things, and examples of complex components include cellular membrane capacitance, among other things. Further, the measured bioimpedance signal can include real and/or complex components associated with arterial structures (e.g., arterial cells, etc.) and the presence (or absence) of blood pulsing through an arterial structure. In some examples, a heart rate signal, or other physiological signals, can be determined (i.e., recovered) from the measured bioimpedance signal by, for example, comparing the measured bioimpedance signal against the waveform of the drive signal to determine a phase delay (or shift) of the measured complex components. The bioimpedance sensor signals can provide a heart rate, a respiration rate, and a Mayer wave rate.

In some embodiments, wearable device 110a can include a microphone (not shown) configured to contact (or to be positioned adjacent to) the skin of the wearer, whereby the microphone is adapted to receive sound and acoustic energy generated by the wearer (e.g., the source of sounds associated with physiological information). The microphone can also be disposed in wearable device 110a. According to some embodiments, the microphone can be implemented as a skin surface microphone (“SSM”), or a portion thereof, according to some embodiments. An SSM can be an acoustic microphone configured to enable it to respond to acoustic energy originating from human tissue rather than airborne acoustic sources. As such, an SSM facilitates relatively accurate detection of physiological signals through a medium for which the SSM can be adapted (e.g., relative to the acoustic impedance of human tissue). Examples of SSM structures in which piezoelectric sensors can be implemented (e.g., rather than a diaphragm) are described in U.S. patent application Ser. No. 11/199,856, filed on Aug. 8, 2005, and U.S. patent application Ser. No. 13/672,398, filed on Nov. 8, 2012, both of which are incorporated by reference. As used herein, the term human tissue can refer to, at least in some examples, as skin, muscle, blood, or other tissue. In some embodiments, a piezoelectric sensor can constitute an SSM. Data representing one or more sensor signals can include acoustic signal information received from an SSM or other microphone, according to some examples.

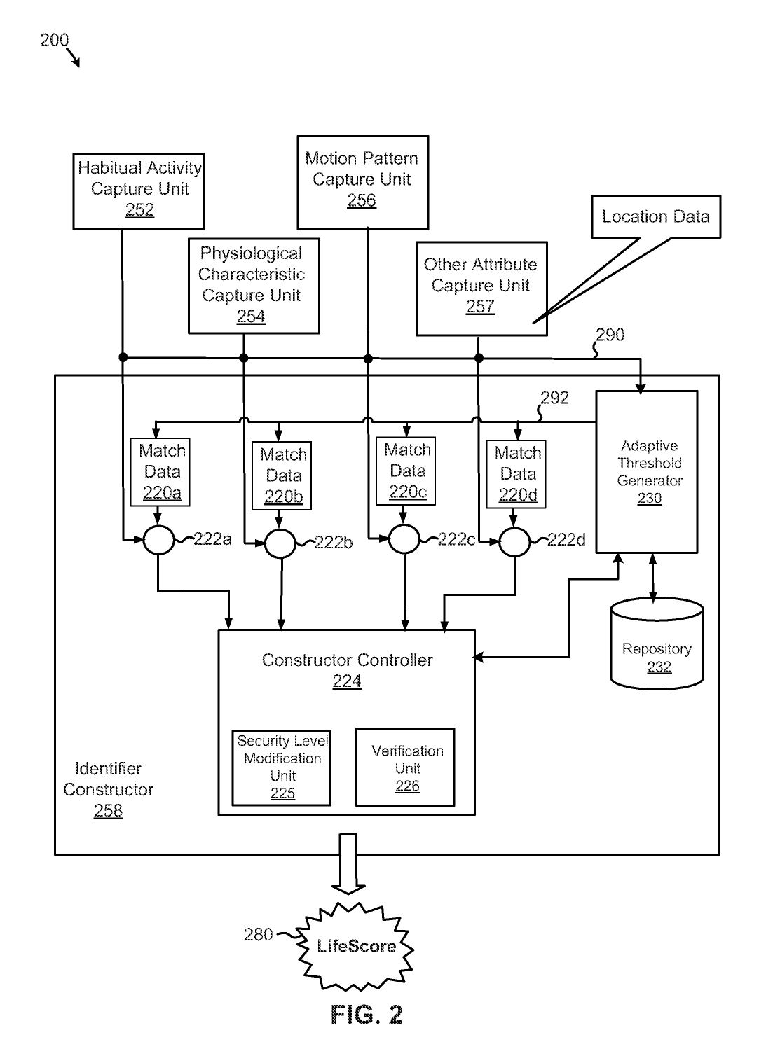

FIG. 2 is a diagram depicting an example of an identifier constructor in association with a wearable device, according to some embodiments. Diagram 200 depicts identifier constructor 258 configured to interact, without limitation, with habitual activity capture unit 252, physiological characteristic capture unit 254, and motion pattern capture unit 256 to generate a biometric identifier (“LifeScore”) 280. Note that identifier constructor 258 is configured to acquire other data to facilitate authentication of the identity of a user. The other data can be used to supplement, replace, modify, or otherwise enhance the use of the data obtained from habitual activity capture unit 252, physiological characteristic capture unit 254, and motion pattern capture unit 256. For example, identifier constructor 258 can be configured to acquire other data from other attribute capture unit 257, which, in this example, provides location data describing the location of a wearable device.

Identifier constructor 258 includes comparator units 222a, 222b, 222c, and 222d to compare captured data from habitual activity capture unit 252, physiological characteristic capture unit 254, motion pattern capture unit 256, and other attribute capture unit 257 against match data 220a, 220b, 220c, and 220d, respectively. Match data 220a, 220b, 220c, and 220d represents data is indicative of the user, whereby matches to the captured data indicates that the user is likely using the wearable device. As such, match data 220a, 220b, 220c, and 220d specifies data for matching captured data to authenticate the identity of a user. Match data 220a, 220b, 220c, and 220d, in some examples, represent adaptive ranges of data values (i.e., tolerances) in which matches are determined to specify the user is positively identified. In some embodiments, each group of match data can represents one or more subsets of data that is identified with the user under authentication. A group of the match data, such as match data 220a, can represent one or more ranges of data that, if the captured data matches (e.g., has values within or in compliance with the one or more ranges of data), then the user is authenticated—at least in terms of that group of match data. The groups of match data are used together to authenticate a user, at least in some cases.

Identifier constructor 258 also includes an adaptive threshold generator 230 configured to provide threshold data for matching against captured data to determine whether a component of biometric identifier 280 (e.g., data from one of habitual activity capture unit 252, physiological characteristic capture unit 254, motion pattern capture unit 256, and other attribute capture unit 257) meets its corresponding threshold. The threshold is used to determine whether the component of biometric identifier 280 indicates a positive match to the user. Adaptive threshold generator 230 is configured to adapt or modify the thresholds (e.g., increase or decrease the tolerances or one or more ranges by which the captured component data can vary) responsive to one or more situations, or one or more commands provided by construction controller 224. In some cases, adaptive threshold generator 230 provides match data 220a, 220b, 220c, and 220d that includes ranges of data acceptable to identify a user.

For example, adaptive threshold generator 230 can adapt the thresholds (e.g. decrease the tolerances to make authentication requirements more stringent) should one of habitual activity capture unit 252, physiological characteristic capture unit 254, and motion pattern capture unit 256 fail to deliver sufficient data to identifier constructor 258. For example, adaptive threshold generator 230 can be configured to detect that data from a pattern of activity (e.g., associated with a habitual activity) and another authenticating characteristic (e.g., such as motion or physiological characteristics) is insufficient for authentication or is unavailable (e.g., negligible or no values). To illustrate, consider that a user is sitting stationary for an extended period of time or is riding in a vehicle. In this case, data from motion pattern capture unit 256 would likely not provide sufficient data representing a “gait” of the user as the limbs of the user are not likely providing sufficient motion. Responsive to the receipt of insufficient gait data, construction controller 224 can cause adaptive threshold generator 230 to implement more strict tolerances for data from habitual activity capture unit 252 and physiological characteristic capture unit 254.

For instance, construction controller 224 can cause adaptive threshold generator 230 to implement more stringent thresholds for habitual activity-related data and psychological-related data. Thus, the shape of a pulse waveform or an ECG waveform may be scrutinized to ensure the identity of a user is accurately authenticated. Alternatively, construction controller 224 can cause adaptive threshold generator 230 to implement location-related thresholds, whereby location data from other attribute capture unit 257 are used to detect whether user is at or near a location associated with the performance of habitual activities indicative of a daily routine. Generally, the more activities performed at locations other than those indicative of a daily routine may indicate that an unauthorized user is wearing the wearable device.

Repository 232 is configured to store data provided by adaptive threshold generator 230 as profiles or templates. For example data via paths 290 can be used to form or “learn” various characteristics that are associated with an authorized user. The learned characteristics are stored as profiles or templates in repository 232 and can be used to form data against which capture data is matched. For example, repository 232 can provide match data 220a, 220b, 220c, and 220d via paths 292. In a specific embodiments, repository 232 is configure to store a template of a user's gait, physical activity history, and the shape and frequency of pulse wave to create a biometric “fingerprint,” such as the LifeScore.

Constructor controller 224 can be configured to control the elements of identifier constructor 258, including the comparators and the adaptive threshold generator, to facilitate the generation of biometric identifier 280. Constructor controller 224 can include a verification unit 226 and a security level modification unit 225. Verification unit 226 is configured to detect situations in which insufficient data is received, and is further configured to modify the authentication process (e.g., increase the stringency of matching data), as described above, to ensure authentication of the identity of a user. Security level modification unit 225 is configured to adjust the number of units 252, 254, 256, and 257 to use in the authentication process based on the need for enhanced security. For example, if the user is on walk in a neighborhood, there may be less need for stringent authentication compared to situations in which the user is at a location in which financial transactions occur (e.g., at an ATM, at a point-of-sale system in a grocery store, etc.). As such, security level modification unit 225 can implement unit 257 to use location data for matching against historic location information to determine whether, for example, a point-of-sale system is one that the user is likely to use (e.g., based on past locations or purchases). Archived purchase information can be stored in repository 232 to determine whether a purchase is indicative of a user (e.g., a large purchase of electronic equipment at a retailer that the user has never shopped at likely indicates that the wear is unauthorized to make such a purchase). Thus, security level modification unit 225 can use this and similar information to modify the level of security to ensure appropriate levels of authentication. In some embodiments, security level modification unit 225 is configured to detecting a request to increase a level of security for authentication of the identity of the user (e.g., logic detects a location or a financial transaction requires enhanced security levels to ensure the opportunities of authenticating an unauthorized user are reduced). Security level modification unit 225 can be configured to modify ranges of data values for a pattern of activity associated with one or more activities (when determining whether a habitual activity) to form a first modified range of data values. Also, security level modification unit 225 can be configured to modify ranges of data values for another authenticating characteristic, such as motion pattern characteristics or physiological characteristics, to form a second modified range of data values. The first modified range of data values and the second modified range of data values makes the authentication process more stringent by, for example, decreasing the tolerances or variations of measured data. This, in turn, decreases opportunities of authenticating an unauthorized user.

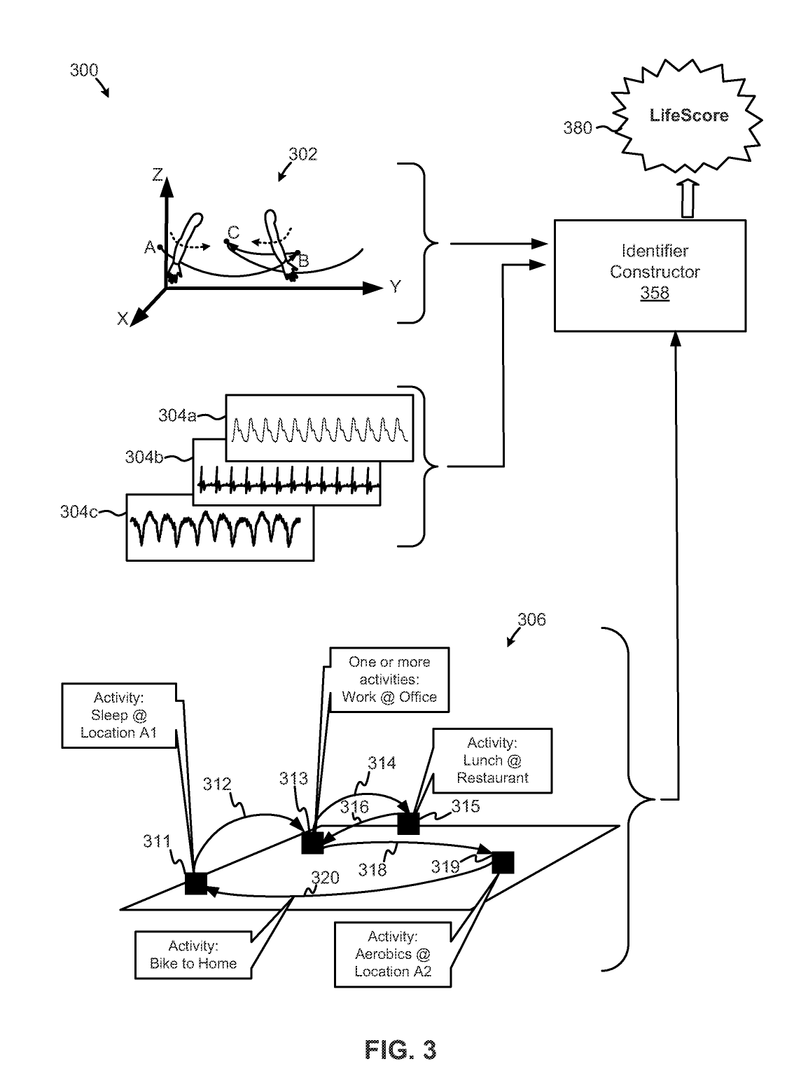

FIG. 3 is a functional diagram depicting an example of the types of data used by an identifier constructor in association with a wearable device, according to some embodiments. Functional diagram 300 depicts an identifier constructor 358 configured to generate a biometric identifier 380 based on data depicted in FIG. 3. For example, biometric identifier 380 may be formed from a first component of data 302 representing gait-related data, and a second component of data 304 representing physiological-related data, such as a pulse pressure wave 304a (or equivalent), ECG data 304b or pulse-related data 304c (including waveform shape-related data, including heart rate (“HR”) and/or pulsed-based impedance signals and data). Further, biometric identifier 380 can be formed from a third component of data 306 that includes activity data (e.g., habitual activity data) and/or location data. As shown, data 306 is depicted conceptually to contain information about the locations, such as a home 311, an office 133, a restaurant 315, and a gymnasium 319. Further, data 306 represents multiple subsets of activity data indicative of activities performed at the depicted locations (e.g., eating lunch). Also, data 306 includes a subset of data 312 (e.g., activity of riding a bicycle to work), subsets of data 314 and 316 (e.g., activity of walking to and from a restaurant), and subsets of data 318 and 320 (e.g., activity of riding a bicycle to a gym and back home). Based on data 302, 304, and 306, identifier constructor 358 can therefore determine biometric identifier 380.

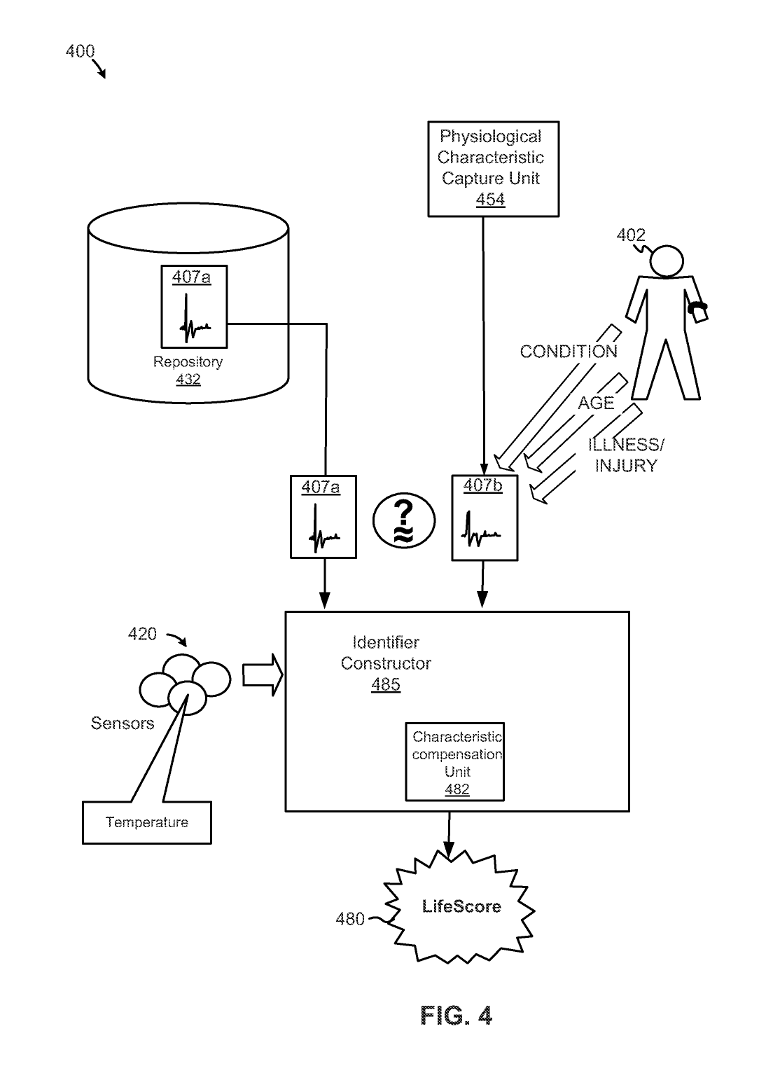

FIG. 4 is a diagram depicting an example an identifier constructor configured to adapt to changes in the user, according to some embodiments. As shown in diagram 400, a user 402 may change habits, or may experience in changes physiological or motion pattern characteristics. Typically, a condition (e.g., pregnancy), age, or illness/injury can impact the physiological or motion pattern characteristics of a user. For example, a user's speech, gait or stepping pattern may change due to injury or accident. Further, a user's pulse wave and heart-rate can change due to illness, age or changes in fitness levels (e.g., increase aerobic capacities and lowered heart rates). Since not all these factors can change at once (or are not likely to at the same approximate time), the determination of LifeScore 480 by identifier constructor 485 can include monitoring the rate(s) of change of one or more of these parameters or characteristics. If one or more of these parameters or characteristics change too quickly (e.g., the rate at which a motion characteristics, habitual activity characteristics, or physiological characteristic changes exceed a threshold that triggers operation of characteristic compensation unit 482 to compensate for such changes), identifier constructor 485 and can flag a change in identification (e.g., positive identification), or the need to modify the authentication process when too many of characteristics change.

In some examples, identifier constructor 485 can include a characteristic compensation unit 482 that is configured to compensate for, or at least identify, changes in user characteristics. Characteristic compensation unit 482 can be configured to detect changes in characteristics, due to injury, accident, illness, age or changes in fitness levels, among other characteristics. Characteristic compensation unit 482 can be configured to compensate for such changes in characteristics by, for example, relying other physiological characteristics (e.g., shifting from heart rate characteristics for authentication to respiration rate characteristics), shift the burden of authentication to another authenticating characteristic by selecting that authenticating characteristic (e.g., enhance scrutiny of habitual activity data or physiological data if motion patterns change due to a physical injury or infirmity to a leg), confirm by other means that there is a detectable explanation of such changes in characteristics, among other courses of action. As to the latter, characteristic compensation unit 482 can be configured to detect and confirm a source of one or more changes in characteristics to ensure authentication. To illustrate, consider that identifier constructor 485 is configured to receive data 407a representing a pulse-related waveform from repository 432 to perform a comparison operation. As shown, captured data 407b from physiological characteristic capture unit 454 indicates a change (e.g., a slight change) in shape of the user's pulse-relate waveform. The change in the shape of a waveform can be caused, for example, by a fever due to a virus. To confirm this, characteristic compensation unit 482 can use a temperature sensor in the subset of sensors 420 to confirm a temperature of the user (e.g., a temperature of 102° F.) indicative of fever. Based on confirmation of the presence of a fever, identifier constructor 485 is more likely to accept captured data 407b as valid data and is less likely to conclude that a user is unauthorized.

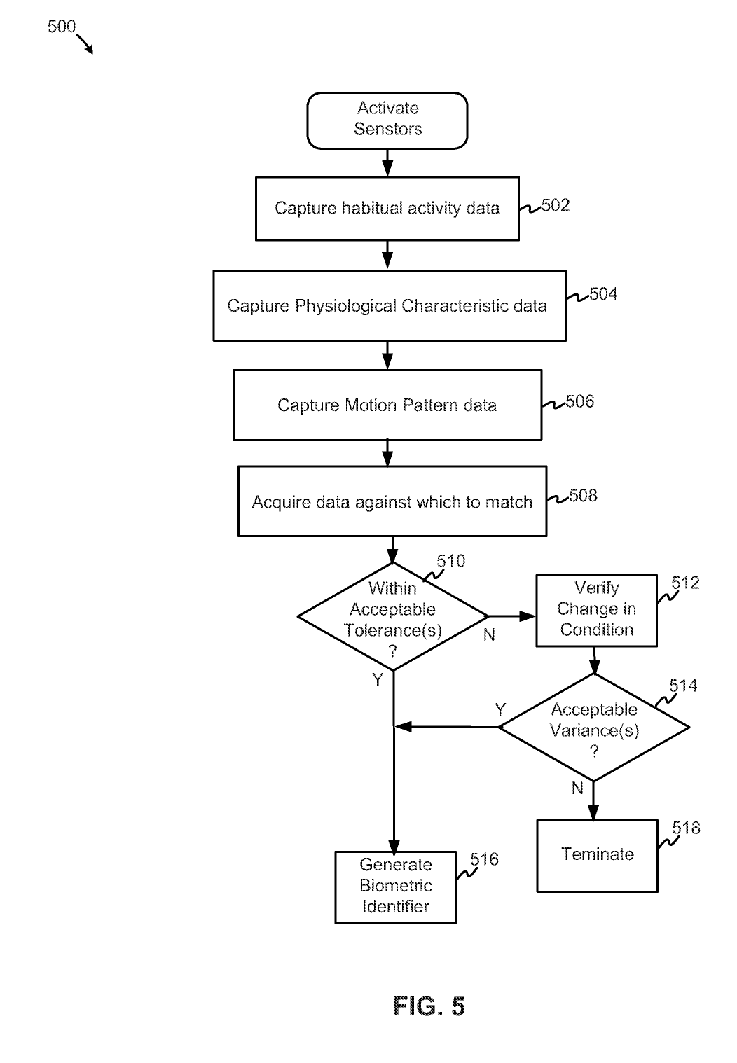

FIG. 5 is an example flow diagram for generating a LifeScore as a biometric identifier, according to some embodiments. At 502, flow 500 activates sensors and captures habitual activity characteristic data. Physiological characteristic data can be captured at 504, and motion pattern characteristic data can be captured at 506. At 508, flow 500 provides for the acquisition of data (e.g., match data) against which to match. At 510, a determination is made as to whether one or more characteristics are within acceptable tolerances to authenticate an identity of a user. If so, flow 500 continues to 516, at which a biometric identifier is generated. If not, flow 500 continues to 512, at which a change in condition may be verified (e.g., a deviation from expected or allowable ranges of data due to, for example, an illness). At 514, a determination is made whether the change in condition (and/or characteristic) is within acceptable ranges of variance. If so, flow 500 moves to 516. Otherwise, flow 500 terminates at 518 as the identity cannot be authenticated to the level as set

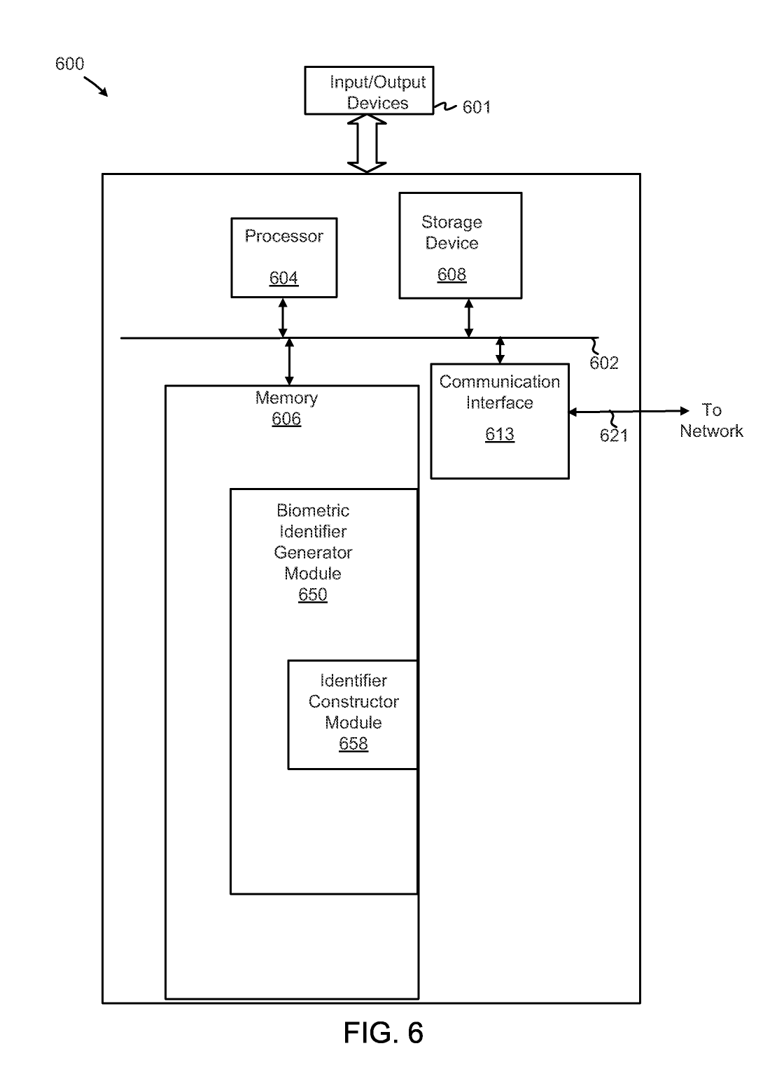

FIG. 6 illustrates an exemplary computing platform disposed in or associated with a wearable device in accordance with various embodiments. In some examples, computing platform 600 may be used to implement computer programs, applications, methods, processes, algorithms, or other software to perform the above-described techniques. Computing platform 600 includes a bus 602 or other communication mechanism for communicating information, which interconnects subsystems and devices, such as processor 604, system memory 606 (e.g., RAM, etc.), storage device 608 (e.g., ROM, etc.), a communication interface 613 (e.g., an Ethernet or wireless controller, a Bluetooth controller, etc.) to facilitate communications via a port on communication link 621 to communicate, for example, with a computing device, including mobile computing and/or communication devices with processors. Processor 604 can be implemented with one or more central processing units (“CPUs”), such as those manufactured by Intel® Corporation, or one or more virtual processors, as well as any combination of CPUs and virtual processors. Computing platform 600 exchanges data representing inputs and outputs via input-and-output devices 601, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 600 performs specific operations by processor 604 executing one or more sequences of one or more instructions stored in system memory 606, and computing platform 600 can be implemented in a client-server arrangement, peer-to-peer arrangement, or as any mobile computing device, including smart phones and the like. Such instructions or data may be read into system memory 606 from another computer readable medium, such as storage device 608. In some examples, hard-wired circuitry may be used in place of or in combination with software instructions for implementation. Instructions may be embedded in software or firmware. The term “computer readable medium” refers to any tangible medium that participates in providing instructions to processor 604 for execution. Such a medium may take many forms, including but not limited to, non-volatile media and volatile media. Non-volatile media includes, for example, optical or magnetic disks and the like. Volatile media includes dynamic memory, such as system memory 606.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 602 for transmitting a computer data signal.

In some examples, execution of the sequences of instructions may be performed by computing platform 600. According to some examples, computing platform 600 can be coupled by communication link 621 (e.g., a wired network, such as LAN, PSTN, or any wireless network) to any other processor to perform the sequence of instructions in coordination with (or asynchronous to) one another. Computing platform 600 may transmit and receive messages, data, and instructions, including program code (e.g., application code) through communication link 621 and communication interface 613. Received program code may be executed by processor 604 as it is received, and/or stored in memory 606 or other non-volatile storage for later execution.

In the example shown, system memory 606 can include various modules that include executable instructions to implement functionalities described herein. In the example shown, system memory 606 includes a biometric identifier generator module 654 configured to determine biometric information relating to a user that is wearing a wearable device. Biometric identifier generator module 654 can include an identifier construction module 658, which can be configured to provide one or more functions described herein.

In some embodiments, a wearable device 110 of FIG. 1 can be in communication (e.g., wired or wirelessly) with a mobile device 130, such as a mobile phone or computing device. In some cases, mobile device 130, or any networked computing device (not shown) in communication with wearable device 110a or mobile device 130, can provide at least some of the structures and/or functions of any of the features described herein. As depicted in FIG. 1 and other figures herein, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in FIG. 1 (or any subsequent figure) can represent one or more algorithms. Or, at least one of the elements can represent a portion of logic including a portion of hardware configured to provide constituent structures and/or functionalities.

For example, biometric identifier generator module 654 and any of its one or more components can be implemented in one or more computing devices (i.e., any mobile computing device, such as a wearable device or mobile phone, whether worn or carried) that include one or more processors configured to execute one or more algorithms in memory. Thus, at least some of the elements in FIG. 1 (or any subsequent figure) can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, biometric identifier generator module 654, including one or more components, can be implemented in one or more computing devices that include one or more circuits. Thus, at least one of the elements in FIG. 1 (or any subsequent figure) can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method comprising:
receiving data specifying a first activity associated with a wearable device including one or more subset of sensors configured to generate sensor data;
identifying a first subset of values for characteristics of the first activity;
receiving data specifying a second activity associated with the wearable device;
identifying a second subset of values for characteristics of the second activity;
determining a pattern of activity based on the first activity and the second activity and the first subset of values and the second subset of values, respectively;
comparing at a processor data representing the pattern of activity against a first subset of match data associated with a habitual activity, the first subset of match data being stored in a repository;
determining the data representing the pattern of activity is within one or more ranges of data values of the first subset of match data; and
authenticating an identity of a user associated with the wearable device.

2. The method of claim 1, further comprising:
generating a biometric identifier responsive to authenticating the identity; and
transmitting the biometric identifier.

3. The method of claim 2, further comprising:
invalidating the biometric identifier responsive to a disassociation between the wearable device and the user.

4. The method of claim 1, further comprising:
forming a biometric identifier as a composite of the pattern of activity and another authenticating characteristic.

5. The method of claim 4, further comprising:
receiving a first subset of sensor data signals including data representing motion characteristics associated with the wearable device;
capturing a motion pattern including the data representing the motion characteristics;
comparing data representing the motion pattern against a second subset of match data; and
determining the data representing the motion pattern is within one or more ranges of data values of the second subset of match data.

6. The method of claim 5, further comprising:
comparing the data representing the motion pattern against a gait pattern of the user as the second subset of match data;
determining the data representing the motion pattern is associated with the gait pattern to form an identified gait pattern; and
authenticating the identity of the user based on at least data representing the identified gait pattern.

7. The method of claim 5, further comprising:
detecting changes in values of a motion characteristic;
monitoring a rate at which the motion characteristic changes;
determining the rate at which the motion characteristic changes exceeds a threshold; and
compensating for the changes in the values of the motion characteristic.

8. The method of claim 7, further comprising:
detecting the changes in values of the motion characteristic associated with a gait pattern of the user;
monitoring a rate at which the motion characteristic changes away from values defining the gait pattern;
determining the rate at which the motion characteristic change exceeds a gait variation threshold; and
compensating for the changes in the values of the motion characteristic.

9. The method of claim 4, further comprising:
receiving a second subset of sensor data signals;
capturing data representing the physiological characteristics based on the second subset of sensor data signals;
comparing the data representing the physiological characteristics against a third subset of match data; and
determining the data representing the physiological characteristics is within one or more ranges of data values of the third subset of match data.

10. The method of claim 8, further comprising:
comparing the data representing the physiological characteristics against a heart rate pattern of the user as the third subset of match data;
determining the data representing the physiological characteristics is associated with the heart rate pattern to form an identified heart rate pattern; and
authenticating the identity of the user based on at least data representing the identified heart rate pattern.

11. The method of claim 9, further comprising:
detecting changes in values of a physiological characteristic;
monitoring a rate at which the physiological characteristic changes;
determining the rate at which the physiological characteristic changes exceeds a threshold; and
compensating for the changes in the values of the physiological characteristics.

12. The method of claim 11, further comprising:
detecting the changes in values of the physiological characteristic associated with a heart rate pattern of the user of the user;
monitoring a rate at which the physiological characteristic changes away from values defining the heart rate pattern;
determining the rate at which the physiological characteristic changes exceeds a heart rate pattern threshold; and
compensating for the changes in the values of the physiological characteristic.

13. The method of claim 4, further comprising:
detecting that data from one of the pattern of activity and the another authenticating characteristic is unavailable; and
modifying adaptively a range of data values of the other of the pattern of activity and the another authenticating characteristic to form a modified range of data values,
wherein the modified range of data values is a reduced range of data values.

14. The method of claim 4, further comprising:
detecting a request to increase a level of security for authentication of the identity of the user;
modifying ranges of data values for the pattern of activity to form a first modified range of data values; and
modifying ranges of data values for the another authenticating characteristic to form a second modified range of data values,
wherein the first modified range of data values and the second modified range of data values decreases opportunities of authenticating an unauthorized user.

15. The method of claim 1, wherein the wearable device includes one or more subset of sensors disposed at a distal portion of a limb at which the wearable device is disposed

16. An apparatus comprising:
a wearable housing configured to couple to a portion of a limb at its distal end;
a subset of physiological sensors configured to provide data representing physiological characteristics;
a subset of motion sensors configured to provide data representing motion characteristics;
a repository configured to store a profile of motion characteristics constituting a gait pattern of a user; and
a processor configured to execute instructions to implement a biometric identification generator configured to:
capture a motion pattern including the data representing the motion characteristics;
compare the data representing the motion pattern against the gait pattern of the user;
determine the data representing the motion pattern is associated with the gait pattern to form an identified gait pattern; and
authenticate the identity of the user based on at least data representing the identified gait pattern.

17. The apparatus of claim 16, wherein the processor is configured to execute instructions configured to:
receive sensor data signals including the data representing the physiological characteristics;
capture data representing a physiological characteristic;
compare the data representing the physiological characteristic against match data; and
determine the data representing the physiological characteristics is within a range of data values of the match data.

18. The apparatus of claim 17, wherein the processor is further configured to execute instructions configured to:
compare the data representing the physiological characteristic against a heart rate pattern of the match data;
determine the data representing the physiological characteristic is associated with the heart rate pattern to form an identified heart rate pattern; and
authenticate the identity of the user based on at least data representing the identified heart rate pattern.

19. The apparatus of claim 18, wherein the processor is further configured to execute instructions configured to:
detecting that one of either the data representing the motion pattern or the data representing the physiological characteristics unavailable; and
modifying adaptively a range of data values of the either the data representing the motion pattern or the data representing the physiological characteristics unavailable,
wherein the modified range of data values is a reduced range of data values to decrease errant authentications of the identity of the user.

20. The apparatus of claim 16, wherein the processor is further configured to execute instructions configured to:
determine a pattern of activity based on a first activity and a second activity;
compare data representing the pattern of activity against another subset of match data associated with a habitual activity;
determine the data representing the pattern of activity is associated with a range of data values of the another match data to form an identified habitual activity pattern; and
authenticate the identity of the user based on at least the identified habitual activity pattern.
